(19) United States
(12) Patent Application Publication
(10) Pub. No.: US 2012/0155538 A1
(43) Pub. Date: Jun. 21, 2012

(54) METHODS AND DEVICES FOR CREATING, DECODING AND TRANSCODING AN ENCODED VIDEO DATA STREAM

(76) Inventors: Andreas Hutter, Munchen (DE); Wenrong Weng, Munchen (DE)

(21) Appl. No.: 13/392,850

(22) PCT Filed: Jul. 19, 2010
(86) PCT No.: PCT/EP2010/060403

§ 371 Date: Feb. 27, 2012

(30) Foreign Application Priority Data
Aug. 27, 2009 (DE) 10 2009 039 095.2

(51) Int. Cl. H04N 7/32

(52) U.S. Cl. 375/240.12; 375/E07.027; 375/E07.243; 375/E07.198

(57) ABSTRACT

An image block is encoded by an inter-layer prediction into a first encoded image block and also encoded into a second encoded image block based on an encoding mode that excludes inter-layer prediction. The encoded first and second image blocks are decoded into reconstructed first and second image blocks, respectively. The first encoded image block is inserted into the encoded video stream. When encoding image blocks by an encoding mode that references the reconstructed first image block, the reference to the reconstructed second image block is changed. The image block encoded in this way is inserted into the encoded video data stream to achieve both a high compression rate with high image quality and low complexity in transcoding that can be used with different end devices by a scalable encoded video data stream, such as a video-on-demand service.

### CROSS REFERENCE TO RELATED APPLICATIONS

This application is the U.S. national stage of International Application No. PCT/EP2010/060403, filed Jul. 19, 2010 and claims the benefit thereof. The International Application claims the benefits of German Application No. 102009039095.2 filed on Aug. 27, 2009, both applications are incorporated by reference herein in their entirety.

### BACKGROUND

Described below are methods and devices for creating, decoding and transcoding an encoded video data stream.

The standard designated ITU H.264/AVC (AVC=Advanced Video Coding) has recently been extended with an enhancement which enables scalable encoding of a video sequence. This enhancement is known as SVC (Scalable Video Coding). The scaling can be configured as local, chronological or SNR (signal-to-noise ratio) scalabilty.

There are currently many implementations of the H.264 standard which support only the AVC part of the standard. Therefore video data streams encoded by SVC must be converted to an AVC-compliant encoded video data stream, i.e. transcoded. A known method for transcoding is that the SVC encoded video data stream is entirely decoded and subsequently encoded into an AVC-compliant video data stream. This procedure is very complex and time-consuming. For this reason, a rewriter functionality which enables simple transcoding was incorporated into the SVC. Jan De Cock et al., “Advanced Bitstream Rewriting From H.264/AVC to SVC”, ICIP 2008, pp. 2472-2475, discloses, for example, an improvement of the rewriter functionality. The rewriter functionality, such as, for example, the improvement according to Cock et al., relates to SNR scalability.

### SUMMARY

An aspect is to provide a method and a device which enable simple transcoding of an SVC-compliant encoded video data stream into an AVC-compliant encoded video data stream for local scalability.

Described below is a method for creating an encoded video data stream, is applied to
an encoded video data stream that includes an image sequence encoded by a first layer and by at least one second layer,
the first layer represents the image sequence with first images in a first image resolution and the second layer (L1, L2) represents the image sequence with second images in a second image resolution,
the images each include a plurality of image blocks,
one of the image blocks of the second images is encoded by an inter-layer prediction as an encoded first image block,
   wherein the following operations are carried out:
creation of a reconstructed first image block by decoding the encoded first image block;
creation of an encoded second image block by encoding the reconstructed first image block on the basis of an encoding mode which precludes inter-layer prediction;
creation of a reconstructed second image block by decoding the encoded second image block;
insertion of the encoded first image block and an identification into the second layer, wherein the identification indicates that, during the encoding of an image block, one of the second images in an encoded image block, the encoding of which gives the reconstructed first image block as a reference, is used as a reference for the reconstructed second image block.

A high compression rate is achieved by the encoding of the image block with the INTER-layer prediction. Through the use of the reconstructed second image block as a reference image block for further image blocks of one of the second images, encoding of the further image blocks is achieved without reference to images of the first layer, so that simple transcoding of the encoded video data stream including at least two layers into a transcoded video data stream including one layer is achievable, since the further image blocks in their encoded form, i.e. as encoded image blocks must be copied only into the transcoded video data stream. Furthermore, with the processing set out above, drift in the transcoded video data stream is prevented. A given image block can assume an arbitrary position within the associated image.

Furthermore, during the encoding of one of the image blocks of the second images that is encoded by an encoding mode which references the reconstructed first image block, the reference to the reconstructed second image block is changed. Thus, instead of referencing the reconstructed first image region, the respective encoding mode of image blocks to be encoded references by a reference to the reconstructed second image blocks, so that creation of the transcoded video data stream is made possible with very little complexity, i.e. computational effort, and very little delay.

In an alternative development, the identification is extended so as to indicate at least one parameter that is used during encoding of the reconstructed first image block into the encoded second image block. This extension of the method ensures simplification during creation of the encoded second image block, since encoding rules can be read directly from the parameter.

The encoding of the encoded image block may reference only a partial region of the reconstructed first image block as the reference, so that an image region of the reconstructed second image block which represents the partial image region is selected as the reference. With this development, the method can also be used for a case where only a partial image region is referenced. This enables an increase in the encoding efficiency.

Furthermore, during creation of the encoded second image block, an INTRA encoding mode, an INTRA prediction mode or a PCM encoding method can be used. By this, the transcoding is significantly simplified, since only references to image regions of reconstructed second images generated by decoding remain.

Also described below is a device for generating an encoded video data stream, wherein
the encoded video data stream includes an image sequence encoded by a first layer and by at least one second layer,
the first layer represents the image sequence with first images in a first image resolution and the second layer represents the image sequence with second images in a second image resolution,
the images each include a plurality of image blocks,
one of the image blocks of the second images is encoded by an inter-layer prediction as a first encoded image block.
   The device includes the following units:
a first unit for creating a reconstructed first image block by decoding the encoded first image block;
a second unit for creating an encoded second image block by encoding the reconstructed first image block on the basis of an encoding mode which precludes inter-layer prediction;
a third unit for creating a reconstructed second image block by decoding the encoded second image block;
a fourth unit for creating the second layer by inserting the encoded first image block and an identification, wherein the identification indicates that, during the encoding of an image block, one of the second images in an encoded image block, the encoding of which gives the reconstructed first image block as a reference, is to be used as a reference for the reconstructed second image block.

The device can also include a fifth unit which is configured for encoding one of the image blocks of the second images, the block being encoded by an encoding mode which references the reconstructed first image block, and the reference to the reconstructed second image block is changed.

Furthermore, the fourth unit can be configured such that the identification can be extended so as to indicate at least one parameter which is usable for encoding the reconstructed first image block into the encoded second image block.

The fifth unit may also be configured such that, if the encoding of the encoded image block has a reference only to a partial region of the reconstructed first image block, an image region of the reconstructed second image block which represents the partial image region is to be selected as the reference.

In a development of the device, the fifth unit can also be configured such that during creation of the encoded second image block, an INTRA encoding mode, an INTRA prediction mode or a PCM encoding method is used.

Advantages of the individual embodiments of the device apply similarly to the respective advantages of the method. Using the units, the method for creating the encoded video data stream can be implemented.

A further aspect is a method for decoding an encoded video data stream, wherein the encoded video data stream is created using the method for the creation thereof, by the following:

Creating a reconstructed image block given the presence of the identification in the encoded video data stream is carried out by decoding the encoded image block of the second layer, which references the reconstructed first image block, wherein for decoding, the reconstructed second image block is used as the reference.

The application of the method is thus also possible when decoding the encoded video data stream without the need to perform transcoding. An end device can therefore decode the encoded video data stream including at least two layers and reproduce the video data stream at an output device, for example, a display screen.

Also described below is a device for decoding an encoded video data stream, wherein the encoded video data stream is created by the device for creation thereof, wherein a sixth unit is provided for creating a reconstructed image block given the presence of the identification in the encoded video data stream by decoding the encoded image block of the second layer, which references the reconstructed first image block, wherein the reconstructed second image block is usable as the reference for decoding.

The method for decoding can be implemented by the sixth unit, wherein the advantages are similar to those of the method for decoding.

Also described below is a method for creating a transcoded video data stream from an encoded video data stream created according to the method for creation thereof wherein, given the presence of the identification in the encoded video data stream, the following is carried out:
creation of a reconstructed first image block by decoding the encoded first image block;
creation of an encoded second image block by encoding the reconstructed first image block on the basis of an encoding mode which precludes an inter-layer prediction;
creation of the transcoded video data stream by inserting the encoded second image block and an encoded image block into the transcoded video data stream, wherein the encoded image block has been encoded by an encoding mode which references the second image block reconstructed by decoding the encoded second image block.

Using this method, the an encoded video data stream with at least two layers can be transcoded into a transcoded video data stream with a single layer. Through the specific encoding of the image blocks which originally reference the reconstructed first image block, the transcoded video data stream can be created with very little effort. It is also advantageous that drift in the images of the transcoded video data stream is prevented.

Finally, a further aspect is to provide a transcoding device for creating a transcoded video data stream from an encoded video data stream which can be created by the device for creation thereof, wherein, given the presence of the identification in the encoded video data stream, the following is carried out:
a first unit for creating a reconstructed first image block by decoding the encoded first image block;
a second unit for creating an encoded second image block by encoding the reconstructed first image block (RBB1) on the basis of an encoding mode which precludes an inter-layer prediction;
a seventh unit for creating the transcoded video data stream by inserting the encoded second image block and an encoded image block into the transcoded video data stream, wherein the encoded image block has been encoded by an encoding mode which references the second image block reconstructed by decoding the encoded second image block.

The transcoding device enables implementation of the transcoding method wherein, by the aforementioned units, the method can be carried out. The advantages are similar to those of the transcoding method.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of an image sequence which can be represented in two image resolutions,

FIG. 2 is a flow diagram and a device for creating an encoded video data stream,

FIG. 3 is a section of an encoded video data stream,

FIG. 4 is a flow diagram and a device for decoding the encoded video data stream,

FIG. 5 is a flow diagram and a device for transcoding an encoded video data stream having two layers into a transcoded video data stream with one layer.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Elements having the same function and mode of operation are identified with the same reference signs in the figures.

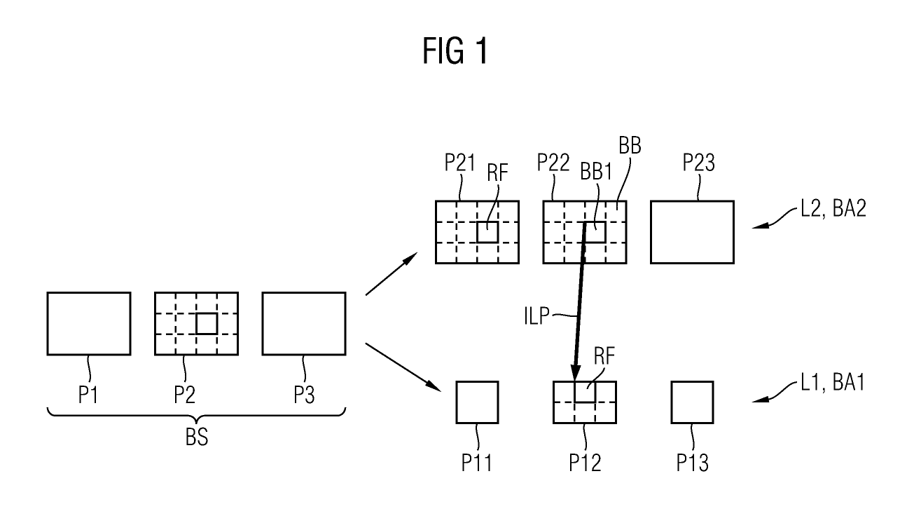

In a scalable video encoding method, such as the SVC standard (SVC=scalable video coding), which is an extension of the existing standard ITU-T H.264 (ITU=International Telecommunications Union), an image sequence BS which contains a plurality of images P1, P2, P3 is encoded in two image resolutions, i.e. quality levels, BA1, BA2 (see FIG. 1). The first image resolution BA1 is represented by a first image sequence with first images P11, P12, P13, which reproduce the image sequence BS in a reduced image resolution, for example QCIF (QCIF=Quarter Common Intermediate Format) with 176×144 image points. In an encoded video data stream VDS, this first image sequence is encoded in a first layer L1, which is also designated as the base layer. A second image resolution BA2, which is better in relation to the first image resolution BA1, is represented by a second image sequence with second images P21, P22, P23. The second image sequence represents the images of the image sequence with an increased image size CIF (CIF=common intermediate format) compared with the first image sequence, having 352×288 image points. The image information of the second image sequence is encoded in the encoded video data stream in a second layer L2 which is also designated as the enhancement layer. It is noteworthy in this regard that the image information of the second image sequence is often encoded predictably depending on the first image sequence, so that a data quantity of the second layer can be significantly reduced. Thus, in practice, the second image sequence is reconstructed by decoding the first and second layers L1, L2.

The images P11, P12, P13, P21, P22, P23 are divided into image blocks BB, BB1, for example, having a size of 4×4 or 8×8 image points. In general, the image blocks can assume arbitrary forms, the sizes given in the H.264 standard being used. The images are encoded in blocks by a video encoder, wherein through the encoding, a reduction in the data quantity is achieved.

The following four encoding modes for the encoding of image blocks are generally known:

INTRA: an image block is encoded without reference to at least one other image block;
INTER prediction: the encoding of an image block of an image is carried out by prediction to an image region, wherein the image region lies in an image chronologically previous or subsequent to the image. This image region is designated as the reference image region or reference RF. Furthermore, the image and the chronologically previous or subsequent image are both part of either the first or the second image sequence. A prediction between image information of the first and the second image sequence does not take place herein.
INTER-layer prediction (ILP): the encoding of an image block of an image takes place by prediction to an image region wherein the image region, that is the reference, lies in a different image from the image block and the image and the other image are encoded in different layers. A prediction therefore takes place between the layers. For example, the image is part of the second image sequence and the other image is part of the first image sequence. The H.264 standard uses the expressions “interlayer-intra” and “interlayer-residual-predicted”, these expressions describing specifically INTER-layer prediction modes.
INTRA prediction: the encoding of an image block of an image is carried out by prediction to an image region, wherein the image region, that is the reference, is situated in the same image as the image block.

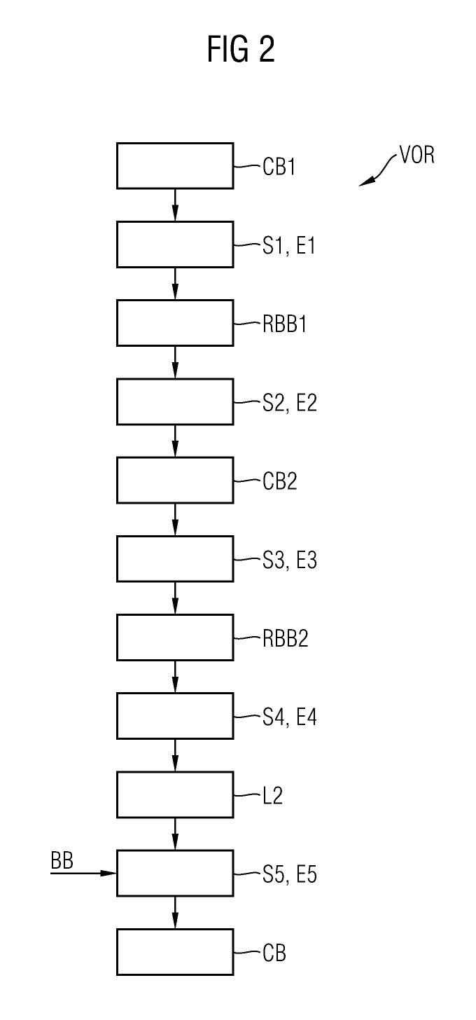

With the aid of FIG. 2, a method for creating an encoded video data stream is described by way of example.

During the encoding of the first image block BB1 of the second image P22, INTER-layer prediction is used as the encoding mode. A reference image region can thus be found in one of the images of the first layer, an image size of the reference image block can be enlarged, for example, in the vertical and horizontal direction by a factor of 2 each, a difference between the reference image region and the first image block can be formed as a difference signal, the difference signal can be encoded by a DCT (DCT=discrete cosine transformation) and subsequent quantization in the form of an encoded first image block CB1. The method can be applied to arbitrary encodings of the difference signal.

In S1, a reconstructed first image block RBB1 is created by a first unit E1 by decoding the encoded first image block CB1. The decoding takes place in inverse manner to the encoding. Due to the quantization during encoding, there are differences between the first image block and the reconstructed first image block.

In S2, an encoded second image block CB2 is created by a second unit E2 by encoding the reconstructed first image block RBB1. It is important in this regard that, for the encoding, only the encoding modes which do not enable any INTER-layer prediction, i.e. which preclude the INTER-layer prediction, are taken into account. Therefore, the INTER prediction mode which, for example, takes account, as the reference image region, of an image region from an image of the second image sequence which chronologically precedes the second image can be used as the encoding mode.

In S3, a reconstructed second image block RBB2 is generated by a third unit E3 by decoding the encoded second image block CB2.

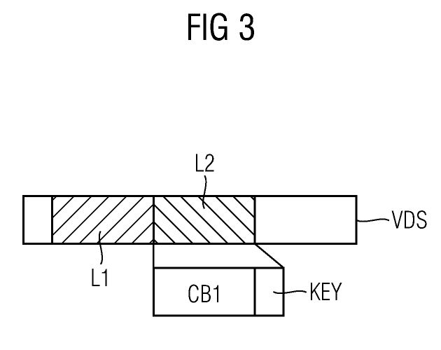

In S4, the encoded first image block CB1 and an identification KEY are inserted by a fourth unit E4 into the encoded video data stream VDS (see FIG. 3).

If, in S5, one of the image blocks of one of the images of the second image sequence is encoded by a fifth unit E5 with one of the encoding modes which references the reconstructed first image block, then in this case, in place of the reconstructed first image block, the reconstructed second image block is used as a reference. If a partial image region of the reconstructed first image block is referenced, then in place of this partial region, the image region of the reconstructed second image block which represents the partial image region of the reconstructed first image block is used as the reference. If, for example, the partial region with 1×4 image points is enlarged by a factor of two in each dimension (up-sampling), then the image region covers 2×8 image points.

The identification KEY indicates that during decoding of an encoded image block CB of the second layer which, as reference image block, indicates the reconstructed first image block RBB1, it is not the reconstructed first image block RBB1 that is to be used as the reference RF, but the reconstructed second image block RBB2. The identification KEY is to be applied similarly for the partial region.

The identification KEY can also be extended so as to indicate parameters which have been used during the encoding of the reconstructed first image block into the encoded second image block. This includes, for example, the encoding mode, such as the INTER prediction encoding, the quantization parameter and the movement vector, which identifies the reference image block used for encoding. This extension can be achieved with the fourth unit E4.

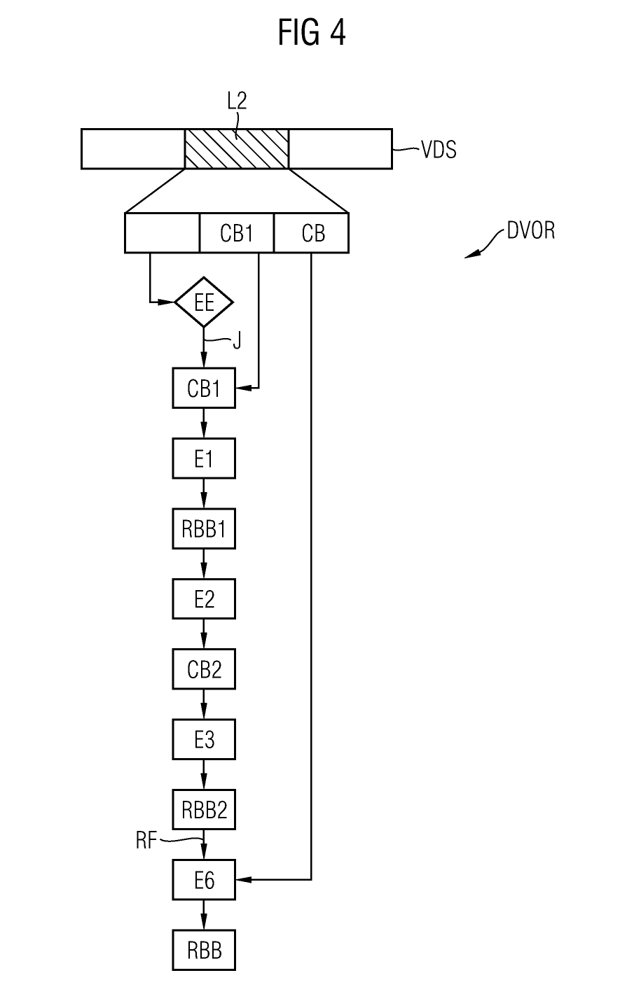

A method for decoding will now be described in greater detail making reference to FIG. 4. A device for decoding DVOR receives the encoded video data stream VDS and attempts to find the identification KEY in step EE. If the identification is recognized (see arrow J), the encoded first image block CB1 is read out from the encoded video data stream VDS and decoded by the first unit into the reconstructed first image block RBB1. By the second unit E2, the reconstructed first image block RBB1 is encoded into the encoded second image block CB2, wherein parameters for performing the encoding can optionally be taken from the identification KEY. The encoded second image block CB2 is transferred by decoding into the reconstructed second image block RBB2. The reconstructed second image block serves as a reference image region RF for decoding the encoded image block CB by a sixth unit into a reconstructed image block.

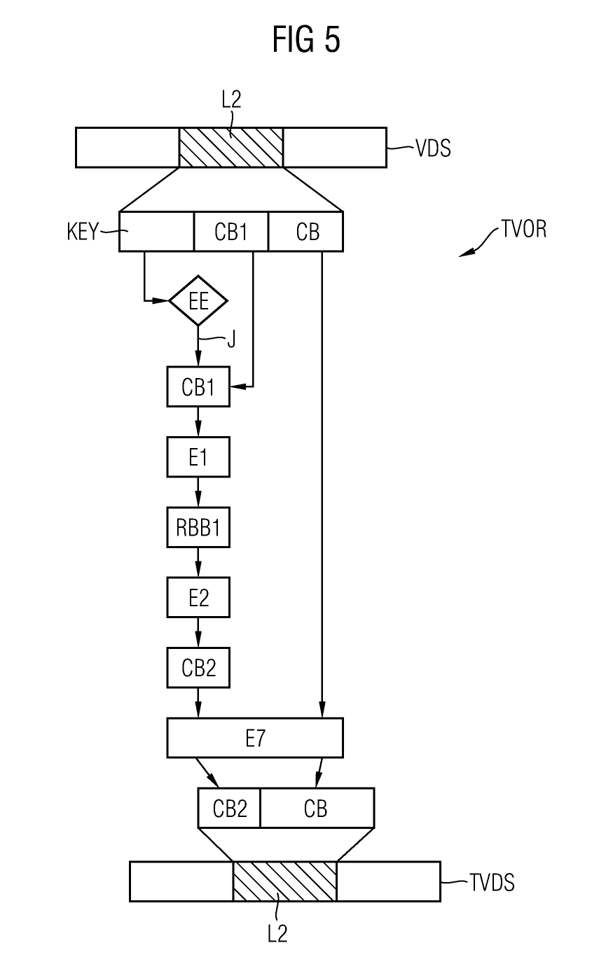

By reference to FIG. 5, a method for transcoding the encoded video data stream VDS into the transcoded video data stream TVDS will now be described in greater detail. A transcoding device TVOR receives the encoded video data stream VDS and analyzes the identification KEY in step EE. If the identification has been recognized (see arrow J), the encoded first image block CB1 is read out from the encoded video data stream VDS and decoded, by the first unit, into the reconstructed first image block RBB1. By the second unit E2, the reconstructed first image block RBB1 is encoded into the encoded second image block CB2, wherein parameters for carrying out the encoding can optionally be taken from the identification KEY. A seventh unit E7 adds into the transcoded video data stream TVDS the encoded second image block CB2 and the encoded image block CB. The encoded image block CB has been encoded by an encoding mode which references the second image block RBB2 reconstructed by decoding the encoded second image block CB2.

In the preceding exemplary embodiments, the encoded second image block CB2 is created by encoding the reconstructed first image block RBB1 using the INTER prediction mode. Alternatively, in place of the INTER prediction mode, the INTRA encoding mode, the INTRA prediction mode or a PCM encoding method (PCM=pulse code modulation) can be used. This has the advantage that, for encoding the encoded second image block CB2, only the reconstructed first image block RBB1 needs to be taken into account. This reduces both the complexity and the storage volume for carrying out the respective method. This alternative concerns the use of the identification KEY, with which, in place of the INTER prediction mode, the INTRA encoding mode, the INTRA prediction mode or the PCM encoding method is signaled depending on which encoding mode has been used for the encoding.

The units E1 to E7 can be implemented and carried out in hardware, software or in a combination of hardware and software, for example, by a computer or a processor with memory module attached. Furthermore, the method which the units carry out can be stored in the form of a program code on a memory medium.

The individual exemplary embodiments can also be combined.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-14. (canceled)

15. A method for creating an encoded video data stream including an image sequence encoded by a first layer and at least one second layer, the first layer representing the image sequence with first images in a first image resolution and the second layer representing the image sequence with second images in a second image resolution, each image having a plurality of image blocks, where a first image block in one of the second images is encoded by an inter-layer prediction as an encoded first image block, comprising:
decoding the encoded first image block to form a reconstructed first image block;
encoding the reconstructed first image block to form an encoded second image block based on an encoding mode which precludes inter-layer prediction;
decoding the encoded second image block to form a reconstructed second image block; and
inserting, into the second layer, the encoded first image block and an identification indicating that, during the encoding of a third image block in one of the second images which references the reconstructed first image block, reference is to be made to the reconstructed second image block instead.

16. The method as claimed in claim 15, further comprising changing a reference to the reconstructed second image block during encoding of the third image block in the one of the second images.

17. The method as claimed in claim 16, wherein the identification also indicates at least one parameter that is used during said encoding of the reconstructed first image block into the encoded second image block.

18. The method as claimed in claim 17, wherein the encoding of the third image block references only a partial region of the reconstructed first image block, and the indication causes reference to be made to an image region of the reconstructed second image block which represents the partial image region.

19. The method as claimed in claim 18, wherein said encoding that forms the encoded second image block uses one of an INTRA encoding mode, an INTRA prediction mode and a PCM encoding method.

20. A device for generating an encoded video data stream including an image sequence encoded by a first layer and at least one second layer, the first layer representing the image sequence with first images in a first image resolution and the second layer representing the image sequence with second images in a second image resolution, each image having a plurality of image blocks, where a first image block in one of the second images is encoded by an inter-layer prediction as an encoded first image block, comprising:
a first decoder decoding the encoded first image block to form a reconstructed first image block;
a first encoder encoding the reconstructed first image block to form an encoded second image block based on an encoding mode which precludes inter-layer prediction;
a second decoder decoding the encoded second image block to form a reconstructed second image block; and
an inserter inserting, into the second layer, the encoded first image block and an identification indicating that, during the encoding of a third image block in one of the second images which references the reconstructed first image block, reference is to be made to the reconstructed second image block instead.

21. The device as claimed in claim 20, further comprising a second encoder encoding the third image block in the one the second images using an encoding mode which references the reconstructed first image block, and changing a reference to the reconstructed second image block.

22. The device as claimed in claim 21, wherein said inserter inserts the identification to also indicate at least one parameter usable for encoding the reconstructed first image block into the encoded second image block.

23. The device as claimed in claim 22, wherein the second encoder in encoding the third image block having a reference only to a partial region of the reconstructed first image block, uses an image region of the reconstructed second image block which represents the partial image region as the reference.

24. The device as claimed in claim 23, wherein the second encoder forms the encoded second image block using one of an INTRA encoding mode, an INTRA prediction mode and a PCM encoding method.

25. A method for decoding an encoded video data stream including an image sequence encoded by a first layer and at least one second layer, the first layer representing the image sequence with first images in a first image resolution and the second layer representing the image sequence with second images in a second image resolution, each image having a plurality of image blocks, where a first image block in one of the second images is encoded by an inter-layer prediction as an encoded first image block, comprising:
decoding an encoded image block of the second layer, which references a reconstructed first image block to form a reconstructed second image block, upon detecting an identification in the encoded video data stream, instead referencing a reconstructed second image block.

26. A device for decoding an encoded video data stream including an image sequence encoded by a first layer and at least one second layer, the first layer representing the image sequence with first images in a first image resolution and the second layer representing the image sequence with second images in a second image resolution, each image having a plurality of image blocks, where a first image block in one of the second images is encoded by an inter-layer prediction as an encoded first image block, comprising:
a decoder decoding an encoded image block of the second layer, which references a reconstructed first image block to form a reconstructed second image block, upon detecting an identification in the encoded video data stream, instead referencing a reconstructed second image block.

27. A method for creating a transcoded video data stream from an encoded video data stream including an image sequence encoded by a first layer and at least one second layer, the first layer representing the image sequence with first images in a first image resolution and the second layer representing the image sequence with second images in a second image resolution, each image having a plurality of image blocks, where a first image block in one of the second images is encoded by an inter-layer prediction as an encoded first image block, comprising:
detecting an identification in the encoded video data stream indicating that when a reference to a reconstructed first image block is used to form a reconstructed second image block, instead reference is to be to a reconstructed second image block;
decoding an encoded first image block to form a reconstructed first image block;
encoding the reconstructed first image block to form an encoded second image block based on an encoding mode which precludes an inter-layer prediction; and
inserting, into the transcoded video data stream, the encoded second image block and an encoded third image block encoded by an encoding mode which references a second image block reconstructed by decoding the encoded second image block.

28. A transcoding device for creating a transcoded video data stream from an encoded video data stream including an image sequence encoded by a first layer and at least one second layer, the first layer representing the image sequence with first images in a first image resolution and the second layer representing the image sequence with second images in a second image resolution, each image having a plurality of image blocks, where a first image block in one of the second images is encoded by an inter-layer prediction as an encoded first image block, comprising:
a decoder decoding an encoded first image block to form a reconstructed first image block;
an encoder encoding the reconstructed first image block to form an encoded second image block based on an encoding mode which precludes an inter-layer prediction; and
an inserter inserting, into the transcoded video data stream, the encoded second image block and an encoded third image block encoded by an encoding mode which references a second image block reconstructed by decoding the encoded second image block.
